(19) United States
(12) Patent Application Publication
(10) Pub. No.: US 2010/0012041 A1
(43) Pub. Date: Jan. 21, 2010

(54) Bird and animal feeder feed supply and replenishment method, and feeder apparatus for implementing end use thereof

(76) Inventor: Lawrence I. Wechsler, Great Neck, NY (US)

Correspondence Address: Lawrence I. Wechsler, One Wooleys Lane, Great Neck, NY, 11023, US

(21) Appl. No.: 12/383,838

(22) Filed: Mar. 26, 2009

Related U.S. Application Data
(60) Provisional application No. 61/072,059, filed on Mar. 26, 2008.

(51) Int. Cl. A01K 39/012

(52) U.S. Cl. 119/52.4; 119/51.01

(57) ABSTRACT

A method includes supplying feed on a commercial basis to an end consumer in pre-measured single-use dispenser packaging, which packaging, when installed to a feeder apparatus of appropriate design, functions as at least a portion of a hopper of the feeder apparatus. When at least partially exhausted of feed, the supplied packaging, serving temporarily as the hopper, is removed and replaced with another filled pre-measured single-use dispenser package. While installed to the feeder apparatus, the commercially supplied feed container filled with the single-use quantity of feed is advantageously visible and functional as part of the hopper conventionally made a permanent and refillable part of the feeder apparatus. As such, simple cartridge replacement of a feed supply is made possible, thereby obviating transfer of feed from the supply packaging to the hopper forming part of the feeder apparatus.

### CROSS REFERENCE TO RELATED APPLICATIONS

This application claims the benefit of U.S. Provisional Application No. 61/072,059 filed Mar. 26, 2008 entitled BIRD AND ANIMAL FEEDER FEED SUPPLY AND REPLENISHMENT METHOD, AND FEEDER APPARATUS FOR IMPLEMENTING END USE THEREOF.

### BACKGROUND OF THE INVENTION

The present invention relates to a commercial method of supplying feed to consumers and a replenishment method in a feeder apparatus which utilizes commercially pre-packaged feed in a manner facilitating a refilling operation by an end use consumer.

A substantial entirety of bird feeders currently on the market are refilled through the open top of some form of feed hopper, which operation further involves removal of a cover or lid which serves to cover the top opening. A refilling operation can be carried out while the feeder remains in a hanging condition, or after the feeder is taken down from the tree limb or other support. In either case, this is invariably a time consuming and relatively difficult task, requiring the use of a ladder and/or necessitating subsequent re-mounting of the entire feeder to the overhead support. In the winter, especially, this can be an unpleasant experience, and one that potentially discourages many from enjoying the pleasurable and rewarding hobby of bird feeding.

Furthermore, as feed is generally supplied in bulk, contained for example in bags weighing several pounds, once a bag is opened to fill a feeder, the remaining feed is often subject to spoilage. For example, in specific regard to bird seed, moths and other pests may breed in the not yet used seed in the opened bags, are a commonly present nuisance. Mold formation is yet another risk, posing a potential health risk to the user and the birds or other animals being fed. Spillage can furthermore create a mess when seed is scattered about a storage area.

It would therefore be desirable to provide a commercial supply method and a feeder apparatus for its implementation by which feed in packaged form could be readily utilized actively in a feeder in a manner overcoming the drawbacks of the prior art.

A further object would provide an approach by which feed which is used would not leave over unused feed which is prone to mold of pest infestation.

A still further object is to provide a supply method by which feed freshness could be maintained until use, and no subsequent storage considerations would be necessary for any unused portion remaining.

A yet further object is to provide a supply method which allows the consumer end user to readily select a particular blend of feed, for example, bird seed, which is suited for a particularly desired bird or birds which are to be attracted and fed thereby.

### SUMMARY OF THE INVENTION

In accordance with these and other objects of the invention, a method comprises supplying feed on a commercial basis to an end consumer in pre-measured single-use dispenser packaging, which packaging, when installed to a feeder apparatus according to the invention, functions as a hopper portion of the feeder. When at least partially exhausted of feed, the packaging serving as the hopper is removed, and is replaced with another filled pre-measured single-use dispenser package. While installed to the feeder apparatus, the commercially supplied feed container filled with the single-use quantity of feed is visible as part of the hopper normally made a permanent and refillable part of the feeder apparatus. As such, simple “cartridge” replacement of a feed supply is made possible, thereby obviating transfer of feed from the supply packaging to the hopper forming part of the feeder apparatus. Risk of spillage during such transfer is thereby avoided, and no unused feed remains in an opened container which might otherwise be exposed to the elements, and the attendant risks associated therewith, discussed above, are thereby obviated.

A first element of a method in accordance with the invention is advantageously carried out by a commercial supplier, and includes packaging of feed by the supplier, for example, bird seed, in containers specially suited for reception to a feed apparatus which is of specific design adapted for accommodating the containers in a manner such that the containers, once received thereto, each serves as the containment hopper of the apparatus from which the feed is dispensed through feeding stations disposed on the feeder apparatus (eg., animal access ports) by operation of gravity, etc. Since, unlike conventional top-fill hopper arrangements, the replaceable containers supplied according to the invention can be exchanged on the feeder apparatus with ease, the size of such containers can advantageously be made smaller than typical hoppers, such that they are not as heavy when filled with fed, thereby facilitating hanging of the apparatus/container from a tree limb or the like, and allowing supply of the filled and sealed containers to the consumer in the form of a convenient multi-pack, such as for example a four or six pack.

Advantageously, the feed supply method according to an embodiment of the invention could be combined with distribution of feeder apparatuses specifically suited to accommodation of the pre-filled containers supplied as part of said supply method, thereby increasing demand for the commercially pre-filled cartridges of feed.

According to another advantageous embodiment, a single feeder apparatus adapted for receiving two or more of the pre-filled feed containers supplied in accordance with the method would permit reception of containers of different feed mixtures formulated to attract different birds, for creating greater consumer interest in bird watching and feeding. The distinct feed blends could be labeled, for example, to indicate the types of birds drawn to the component seeds, and/or for what part of the country (or world) the mixture is intended as dictated by particular bird population ranges.

An advantageous feature of the invention is to provide seed in hulled form (outer hulls removed). Many prefer such form of seed, since birds consuming the seed do not leave any uneaten hulls on the patio or ground below, which must be cleaned by the user. Moreover, the problem of sprouting seeds which may fall to the ground is not encountered in hulled seeds. However, since most antioxidants which protect the seeds from spoilage are located in the protective shell, it was heretofore not readily possible to retard spoilage when packaged in conventional bags. It is deemed advantageous to the invention, therefore, to protect the feed in the pre-filled containers from premature spoilage, by making the containers airtight, and including suitable oxygen and/or moisture scavenger packets or other similar articles within the container, conveniently attached to the lid, such that when the container is opened for use, the protective article is separated from the feed, and cannot therefore accidentally enter the internal regions of the feeder apparatus to which the container is to be installed.

A wide array of feeder designs are contemplated for suitably accommodating and utilizing the pre-filled and commercially supplied feed containers, and it is noted that the method according to the invention which includes the commercial supply of feed in pre-filled containers and the subsequent installation of these same containers to a feeder apparatus to thereby comprise at least a portion of the hopper section of the structural makeup of the overall feeder while transferring feed therein to at least one feed port is not intended to be limited to any particular design of a feeder. Therefore, while examples of feeder designs suitable for practice of the inventive method are shown and described herein, this is by way of illustrative example only, in order to demonstrate the feasibility of the method and to underscore the wide range of possible designs which would allow for commercial supply of pre-filled cartridges of feed, thereby permitting facilitated replenishment of a feed supply in a feeder, even at times of inclement weather or inhospitable outdoor winter conditions.

Because of the need for maintaining the unit cost for feed supplied in accordance with the packaging and supply method of the invention at a price which will be competitive with bulk seed available for purchase in conventional bags, measures are advantageously taken to reduce packaging costs associated with the containers used in commercial practice of the method. Since bottling of the feed may not take place at the feed harvesting/processing plant nor at the manufacturing plant which produces the containers themselves, shipping of empty containers may be required. Therefore, to reduce attendant freight charges, the containers are advantageously produced in a configuration that allows stacking of the containers in nested fashion, one inside the other. Size of the shipment is thereby significantly reduced.

Another approach to minimizing cost is use blow molded bottles of suitable material, such as commonly used for soda bottles. Such material is strong, lightweight and inexpensive, and provides superior clarity which is particularly desirable for visible display of the seeds by advantageously aiding in attracting birds to feed.

The above, and other objects, features and advantages of the present invention will become apparent from the following description read in conjunction with the accompanying drawings.

### BRIEF DESCRIPTION OF THE DRAWINGS

FIG. 1 is a side perspective view of an advantageous illustrative example of a feeder apparatus adapted for utilizing commercially pre-packaged feed supplied in a container which serves as at least part of the hopper when installed in a manner facilitating a refilling operation by an end use consumer in accordance with the invention;

FIG. 2 a side cross-sectional view if a commercially pre-filled feed contained according to an embodiment of the invention;

FIG. 3 is a detailed exploded view, shown in partial cross-section, of an optional shutter valve mechanism provided in the feed coupling operable to inhibit loss of feed when the filled container is inverted to be installed to the feeder of FIG. 1, and then which can be opened to initiate flow of feed to the feeder apparatus when installation is complete; and

FIG. 4 is a cross-sectional side view of a stack of nested containers according to an advantageous embodiment of the invention, which reduces shipping costs by tight packing the empty containers prior to filling by the commercial entity with feed to be supplied to the consumer.

### DETAILED DESCRIPTION OF THE PREFERRED EMBODIMENT

As noted above herein, in accordance with the broad objective of the invention, feed is commercially supplied to the end consumer in a container adapted for use in a feeder apparatus of specific construction to allow accommodation of the container in which the commercially pre-filled feed is held on the feeder to thereby serve as at least a part of the hopper for supplying feeding station(s)/port(s) of the feeder apparatus with feed for consumption by an animal, for example, a bird.

It is contemplated that many container and/or feeder apparatus designs will be appropriate for satisfying the requirement necessary for achieving this objective, and that specific designs are not critical for the underlying premise of the invention, which resides, in the broadest of terms, in a method of facilitating replacement of exhausted feed in a feeder by installation of a pre-filled feed container (cartridge) to the feeder, and subsequent replacement thereof with another pre-filled container, when the first is depleted of feed.

A refilling feature has previously been suggested for use in an animal feeder which is suitable for implementation in connection with practice of the invention. In U.S. Patent Application Publication 2005/0028743 A1, a reservoir can be replaced without significant loss of feed by inversion of the reservoir, and detachment thereof from a remainder of the feeder structure when the opening of the reservoir is above at least a portion of the reservoir containing feed. The disclosure of US 2005/0028743 A1 is herein incorporated by reference for all relevant teachings applicable to practice of the disclosed invention. For example, the reservoir disclosed in the prior reference mentioned above could readily be commercially pre-filled with feed and sealed, and provided to the user of the disclosed feeder for replacement thereto as required.

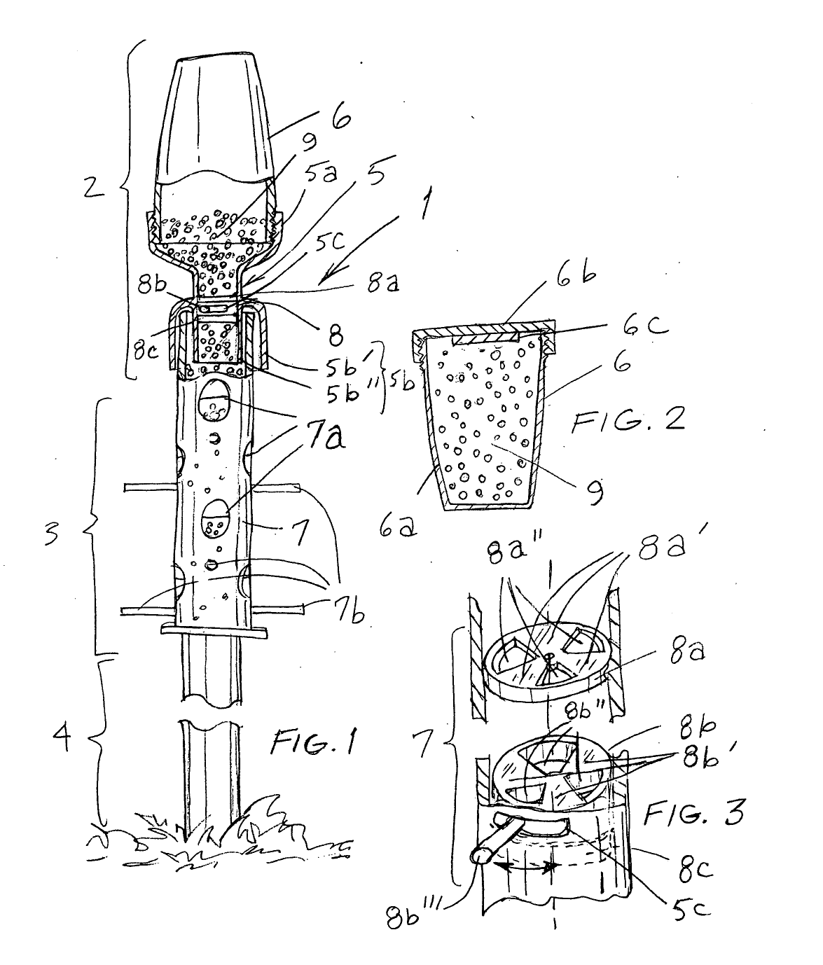

In order to illustrate the myriad possibilities for implementation and applicability of the feed supply method according to the invention in relation to feeder apparatuses designed to accommodate containers supplied in furtherance thereof, another suitable feeder design example is depicted in FIG. 1, merely by way of example of many available alternatives.

Referring to FIG. 1, a pole mounted bird feeder, generally designated 1, includes a feed supply portion 2, a feeding portion 3, and a ground elevation support portion 4 (conveniently, a pole driven into the ground for support). Feed supply portion 2 includes a feed coupling 5 which couples a feed container 6, advantageously supplied in accordance with the method according to the invention, to the feeding portion 3.

Feeding portion 3 includes a feeder body 7 (conveniently of generally tubular construction, as shown in the example) having feed ports (feed stations) 7a and perches 7b, conveniently of typical construction. Feed container 6 is conveniently coupled to the feeding portion 3 by feed coupling 5. In this regard, feed coupling 5 advantageously includes a threaded portion 5a which threadably engages correspondingly configured threads on feed container 6, and a feeder engagement portion 5b for holding the feed supply portion 2 atop the feeding portion 3.

Feeder engagement portion 5b includes an outer tubular portion 5b′ and a smaller diameter inner tubular portion 5b″ dimensioned to respectively surround and be inserted into the open top of the tubular structure of the feeder body 7. As such, lateral or tilting movement of the feed supply portion 2 is inhibited, and removal thereof from the feeding portion 3 requires lifting of the feed supply portion 2 upward.

FIG. 2 depicts a commercially pre-filled container 6, including a container portion 6a and a lid 6b (advantageously of screw-on, threaded design as mentioned above) for also advantageously sealably enclosing feed contents 8, and keeping the same fresh, during storage and prior to use by the end user. An optional device 6c is provided for absorbing oxygen and/or releasing antioxidant agents into the feed contents, device 6c being advantageously fixably mounted on the lid 6b.

As noted above, an advantageous feature of the invention is to provide seed 8 in hulled form (outer hulls removed). Many prefer such form of seed since birds consuming the seed do not leave any uneaten hulls on the patio or ground below, which must be cleaned by the user. Moreover, the problem of sprouting seeds which may fall to the ground is not encountered in hulled seeds. Since most antioxidants which protect the seeds from spoilage are located in the protective shell, the use of device 6c provides a realistic approach for protecting the seed 8 from degradation prior to usage in a sealed and fully enclosed reservoir 6.

A selective feed shutoff device 8 is advantageously provided as part of feed coupling 5 for selectively inhibiting outward flow of seed 9 (or other feed contents) from the feed container 6 when inverted and detached from the feeding portion 3, and for selectively allowing flow to the feeding portion when reoriented to an open position once mounted atop feeding portion 3. Feed shutoff device 8 is conveniently disposed in or above inner tubular portion 5b″, and includes an upper shutter element 8a and a lower shutter element 8b. The details of construction and operation of the feed shutoff device 8 are best seen with reference to FIG. 3.

Turning now to FIG. 3, feed shutoff device 8 includes a fixed portion, provided in the example as upper shutter element 8a (but which could alternatively be provided in a lower rather than the upper position) conveniently molded integrally with the structure of feed coupling 5. Upper shutter element 8a includes a series of shutters 8a′ circumferentially interspersed with feed passage openings 8a″. Feed shutoff device 8 further includes a movable lower shutter element 8b (which could alternatively be instead in an upper position) which also includes a series of shutters 8b′ circumferentially interspersed with feed passage openings 8b″. Lower shutter element 8b is rotatable such that the shutters 8a′ and 8b′ can be aligned to allow flow through the also aligned feed passage openings 8a″ and 8b″. When the shutters 8a′ and 8b′ of lower and upper shutter elements 8a and 8b are staggered in the circumferential direction, passage of feed therepast is inhibited, by blockage of the respective feed passage openings 8a″ and 8b″ by the shutters 8a′ and 8b′. A lever 8b′″, attached radially to lower shutter element 8b, and which protrudes through and rides in a slot 5c in feed coupling 5, allows externally actuated pivoting of the lower shutter element 8b to move same between the feed flow position and the feed inhibited position as indicated by the arrow shown in FIG. 3. Lower shutter element is conveniently held in place rotatably by a retainer 8c press-fit inside inner tubular portion 5b″ of feed coupling 5.

While two example of feeder designs are given by way of example above, it is reiterated that a wide array of feeder designs are contemplated for suitably accommodating and utilizing the pre-filled and commercially supplied feed containers. In this regard, it is noted that the method according to the invention, which includes the commercial supply of feed in pre-filled containers and the subsequent installation of these same containers to a feeder apparatus to thereby comprise at least a portion of the hopper section of the structural makeup of the overall feeder while transferring feed therein to at least one feed port, is not intended to be limited to any particular design of a feeder.

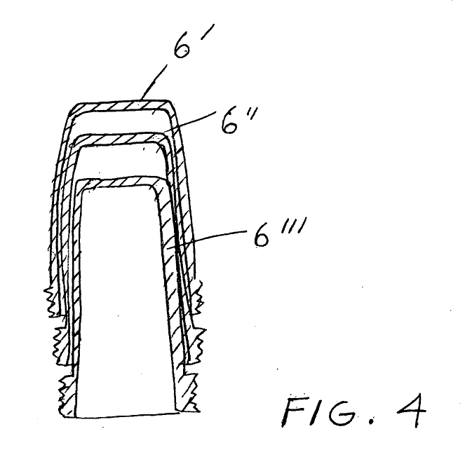

In order to reduce packaging costs associated with the containers used in commercial practice of the method, various measures are deemed advantageous in connection with implementation of the disclosed method of feed supply. Particularly, since packaging of the feed may not take place at the feed harvesting/processing plant nor at the manufacturing plant which produces the containers themselves, shipping of empty containers may be required. Therefore, to reduce attendant freight charges, the containers are advantageously produced in a configuration that allows stacking of the containers in nested fashion, one inside the other, as shown, for example, in FIG. 4. FIG. 4 depicts in cross-section, three containers 6′, 6″, 6′″ respectively configured to allows stacked nesting of the containers, one within another, such that a size of the shipment contents is thereby significantly reduced, and costs associated with shipping thereof minimized.

Another approach to minimizing cost, and which needs no depiction, is the use of blow molded bottles of suitable material, such as is commonly used for production of soda bottles. Such material is strong, lightweight and inexpensive, and provides superior clarity which is particularly desirable for visible display of the seeds by advantageously aiding in attracting birds to feed.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A method of commercially supplying feed for use in a feeder apparatus, comprising:
configuring containers to be receivable to a feeder apparatus of suitable construction to allow feed contents of a one of said containers to be transferred from said one of said containers to a feeding station of said feeder apparatus when in received engagement thereto;
pre-filling said containers with the feed and sealing the containers once filled to produce pre-filled containers of feed; and
supplying said pre-filled containers of feed to an end user for use as at least a part of a feed hopper structure of a feed supply in said feeder apparatus in a possession of the end user.

2. A bird feeder, comprising:
a feeding portion including feed ports at which feed is accessible by an animal; and
a feed supply portion communicative with the feeding portion, said feed supply portion being comprised of a given one of commercially pre-filled containers received to the bird feeder at times of use, and which is replaceable with another of said commercially pre-filled containers.

3. A bird feeder according to claim 2, further comprising:
a selective feed shutoff device for selectively inhibiting outward flow of feed from the pre-filled containers when inverted and detached from communication with the feeding portion, and for selectively allowing flow to the feeding portion when reoriented to an open position once mounted in communication with said feeding portion.
